(19) United States
(12) Patent Application Publication
(10) Pub. No.: US 2008/0306757 A1
(43) Pub. Date: Dec. 11, 2008

(54) Server, settlement system and recording medium

(75) Inventors: Shigenori Morikawa, Tokyo (JP); Yasukazu Ohira, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/151,248

(22) Filed: May 5, 2008

(30) Foreign Application Priority Data
May 14, 2007 (JP) 2007-127992

(51) Int. Cl. G06Q 99/00; G06F 15/16

(52) U.S. Cl. 705/1; 709/201

(57) ABSTRACT

A server device comprises: a first communication unit for communicating with a sales data processor and a settlement center; a first storage unit; and first control means for receiving sales data via the first communication unit from the sales data processor, for storing the sales data in the first storage unit, for receiving settlement data via the first communication unit from the sales data processor, for sending the received settlement data to the settlement center, for storing the settlement data in the first storage unit, and for processing the sales data and the settlement data stored in the first storage unit in an associated manner.

### BACKGROUND OF THE INVENTION

1. Field of the Invention

The present invention relates to servers, settlement systems, and recording media.

2. Background Art

In the past, ECRs (Electronic Cash Registers) are set up in stores which sell commodities to perform an accounting process for those commodities sold. ASP (Application Service Provider) services and systems have been proposed which collect/analyze sales data for respective ECRs (for example, see Published Unexamined Japanese Patent Application 2003-308375). A system has also been proposed which electronically settles payment for commodities which a customer purchased with his or her credit card or cell phone (for example, see Published Unexamined Japanese Patent Application 2004-139302). This system connects settlement terminals to a settlement center server via phone lines, private lines and/or communications networks.

Now, referring to FIG. 20, a conventional settlement system 2 is described which includes the functions of collecting sales data and settling the accounts electronically. As shown in FIG. 20, the settlement system 2 comprises electronic settlement terminals 30a-30c, a settlement center server 50, a credit card company server 60, ECRs 20a-20c, and a head office server 500. The electronic settlement terminals 30a-30c are connected via a communications network N1 such as an INFOX to the settlement center server 50 which may be a CAFIS™ (Credit And Finance Information System), which is a credit card settlement system that connects credit card companies/banks and stores/enterprises in the whole country. The settlement center server 50 is connected communicably to the card company server 60. The ECRs 20a-20c are connected communicably to the head office server 500 via a communication network N2 such as private lines. In this example, the head office of an enterprise controls three stores and has set up the head office server 500 therein. Further, the three stores each have set up an electronic settlement terminal and an ECR therein; i.e. 30a, 20a; 30b, 20b; and 30c, 20c, respectively.

The head office server 500, receives sales data from the three store ECR 20a-20c, totals up and analyzes the sales data. In the electronic settlement, the terminals 30a-30c read card information from a customer's card/cell phone. Settlement data including the card information are then sent from the respective terminals 30a-30c via the network N1 to the settlement center server 50, which in turn sends the settlement data to the corresponding card company server 60, which determines whether the settlement should be approved and sends a result of the determination to the settlement center 50. Then, the center 50 sends the result of the determination to the terminals 30a-30c, which then perform a settlement process.

However, in the conventional settlement system 2, a POS (Point Of Sales) system section (including the head office server 500 and the ECRs 20a-20c) which totals up the sales data is provided independently of a settlement system section (including the electronic settlement terminals 30a-30c and the settlement center server 50) which performs an electronic settlement. The POS system section requires a peculiar communications network configuration (for example, communications network N2), a dedicated server (for example, head office server 500) and a private software application.

The POS system section is configured such that the head office server 500 collectively performs a commodity registration/management operation and causes each of the ECRs 20a-20c to send POS registration data to the head office server 500 each time a single processing operation of the ECR ends. Thus, the POS system section manages and registers various commodities in a united manner and manages sales data in real time. Therefore, the POS system section is large-scaled and the ECRs are expensive. Accordingly, it is difficult for general proprietors/executives who run a single or a small number of retail shops or stores to introduce a POS system.

Shops or stores which use an inexpensive ECR have an advantage that they are not required to manage sales data in real time. However, even such shops or stores are required to total up daily takings. In this case, a PC (Personal Computer) captures sales data stored in the ECR through a memory card or serial communication and totals up the sales data with the aid, for example, of a software accounting application. When the data is captured from the memory card, the manager is required to go the rounds of the ECRs with the memory card to collect the sales data. When capturing the sales data through the serial communication, the PC is required to be set up in the vicinity of the ECR of each shop or store.

Since in the settlement system 2 the POS system section is separated from the settlement system section, the data is required to be keyed in both at a respective one of the ECR 20a-20c and at a corresponding one of the electronic settlement terminals 30a-30c, which imposes a double key-in operation or a large load on the operator, which may lead to making input mistakes.

Further, since in the settlement system 2 the sales data and the settlement data are stored in the head office server 500 and the settlement center server 50, respectively, the sales data cannot be processed in association with the settlement data.

It is an object of the present invention to process the sales data and the settlement data in an associated manner.

### SUMMARY OF THE INVENTION

A server device comprises: a first communication unit for communicating with a sales data processor and a settlement center; a first storage unit; and first control means for receiving sales data via the first communication unit from the sales data processor, for storing the sales data in the first storage unit, for receiving settlement data via the first communication unit from the sales data processor, for sending the received settlement data to the settlement center, for storing the settlement data in the first storage unit, and for processing the sales data and the settlement data stored in the first storage unit in an associated manner.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram of a settlement system 1 of one embodiment of the present invention;

FIG. 2 is a block diagram of an information center sever 10;

FIG. 3 is a block diagram of an ECR 20A;

FIG. 4 is a block diagram of an electronic settlement terminal 30A;

FIG. 5 is a block diagram of a PC 40A;

FIGS. 6A and B illustrate the structures of sales data 90 and 100 stored in the ECR 20A and the information center server 10, respectively;

FIG. 7 illustrates the structure of a credit sales management table 200 stored in the information center server 10;

FIG. 8 illustrates the structure of a settlement data storage unit 300 of the information center server 10;

FIG. 9 is a flowchart of an ECR process to be performed in the ECR 20A;

FIGS. 10A and B illustrate receipts P1 and P2 involving electronic and cash settlements, respectively;

FIG. 11 is a flowchart of a settling process to be performed by the electronic settlement terminal 30A;

FIG. 12 is a flowchart of a process to be performed in the information center server 10;

FIG. 13 is a flowchart of a sales data process in the information center server 10;

FIG. 14 is a flowchart of a periodic process to be performed in the information center server 10;

FIGS. 15A-15B illustrate settlement data 310 and 320 involving various and single card companies, respectively;

FIG. 16 is a flowchart of an accessing process to be performed by the PC 40A;

FIGS. 17A-17C show different data input pictures 441, 442, and 443, respectively;

FIG. 18 illustrates one example of selections of a range of sales data to be totaled up;

FIG. 19 is a flowchart of a sales analysis process; and

FIG. 20 is a block diagram of a conventional settlement system 2.

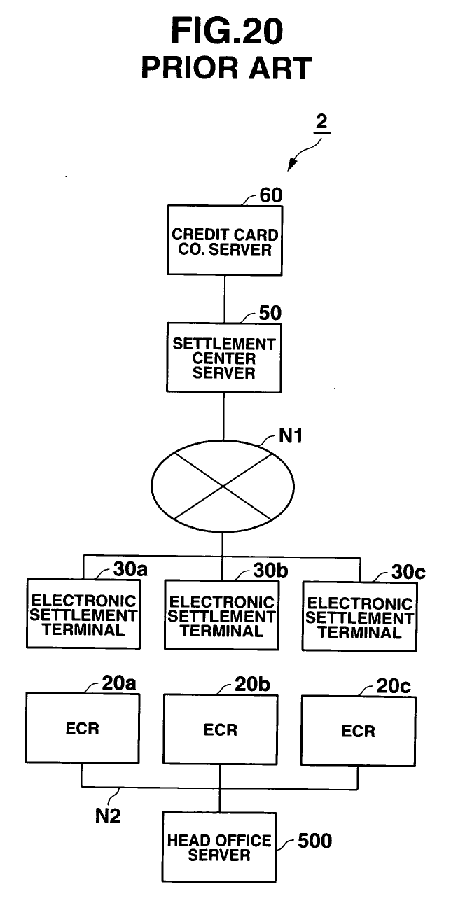

### DETAILED DESCRIPTION OF THE PRESENTLY PREFERRED EXEMPLARY EMBODIMENT

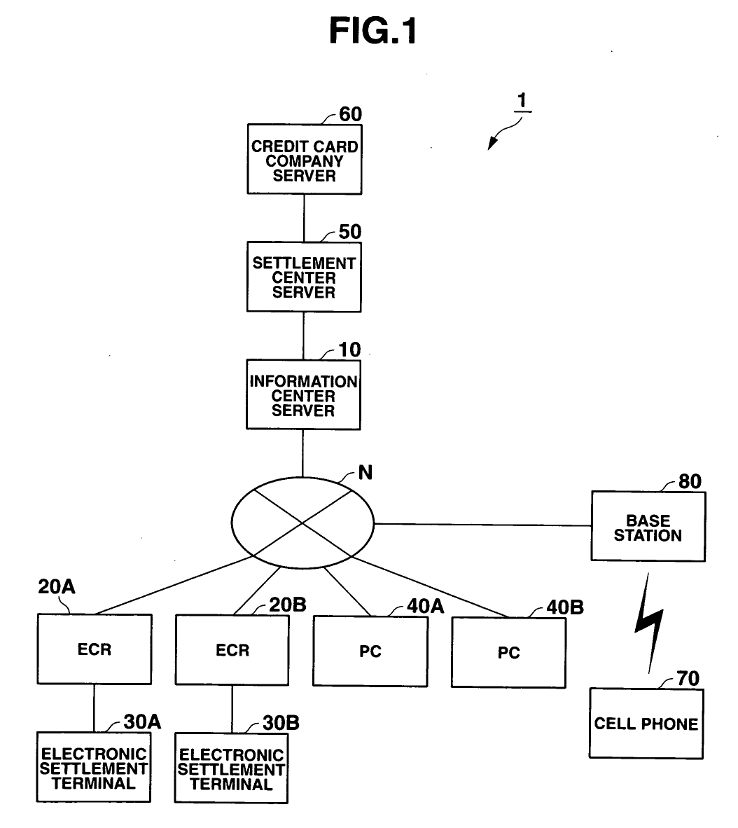

First, referring to FIGS. 1-5, the structure of an embodiment of the present invention is described. FIG. 1 illustrates the structure of a settlement system 1 of the embodiment.

As shown in FIG. 1, the settlement system 1 comprises an information center server 10, ECRs 20A and 20B as a sales data processor, electronic settlement terminals 30A and 30B, PCs 40A and 40B as an accessing unit, a settlement center server 50, a credit card company server 60, a cell phone 70 as an accessing unit, and a base station 80. The information center server 10 is communicably connected via the communication network N to the ECRs 20A, 20B, the PCs 40A, 40B and the base station 80. The ECRs 20A and 20B are connected to the electronic settlement terminals 30A and 30B, respectively. The settlement center server 50 is connected to the information center server 10 and the card company server 60.

Assume that the ECR 20A and electronic settlement terminal 30A belong to and are set up in a first store of a company which a first owner manages. Also, assume that the ECR 20B, electronic settlement terminal 30B belong to and are set up in a second store of a company which a second owner manages. Further, assume that the PCs 40A and 40B are set up in the first and second owners' offices, respectively. While the cell phone 70 is described as owned by the first owner, it may be likewise described as owned by the second owner as required for convenience of explanation.

It is noted that the number of owners, the number of stores which one owner manages and the respective numbers of ECRs and electronic settlement terminals set up in one store are not limited to the embodiment illustrated in FIG. 1.

The ECRs 20A and 20B as the sales data processor perform an accounting process for their allocated store. The ECRs 20A and 20B store sales data received in the accounting process and send the sales data to the information center sever 10, for example, each time their daily business time ends.

The electronic settlement terminals 30A and 30B are connected to the ECRs 20A and 20B, respectively. The terminals 30A and 30B read card information from a customer's credit card C1 or cell phone C2, which is described later, and then send settlement data, which will be described in detail later, and including the card information, and a settlement approval request to the card company server 60. The credit card C1 is a magnetic card with a magnetic stripe line or an IC (Integrated Circuit) card of an IC chip which is used in a contact or non-contact manner for communication. The cell phone C2 has the function of communicating with the ECRs 20A and 20B and other communication devices in a non-contact manner.

The PCs 40A and 40B function as a terminal that totals up and analyzes sales data stored in the information center server 10. The cell phone 70 has similar functions to the PCs 40A and 40B.

The information center server 10 stores the sales data received from the electronic settlement terminals 30A and 30B. The information center server 10 has a sales data managing function which totals up and analyzes sales data stored therein and sends resulting data to the PC 40A or 40B or cell phone 70 at its request. The information center server 10 also has a settlement/management function which sends the card company server 60 the settlement approval request received from the electronic settlement terminal 30A or 30B, sends a result of determination about the approval request for the settlement received from the card company 60 to the terminals 30A or 30B and then stores therein data on the result of determination in association with the sales data.

The settlement center server 50 is connected between the owner and the card company so as to manage communication of information on the settlement between the card company server 60 and the information center server 10. The card company server 60 belongs to each card company. While in FIG. 1 the card company server 60 is illustrated as a single one, actually, a plurality of credit card company servers 60 are provided to a like number of card companies, respectively.

The settlement center sever 50 receives settlement data and a request for approval of the settlement data, which the terminals 30A or 30B sent, from the information center server 10, and then sends the data and the request to the card company server 60 concerned. On receiving the settlement data and the approval request, the card company server 60 determines whether the approval request should be approved. Then, the server 60 sends the settlement center server 50 a result of the determination including an approval number if the request is approved. The sever 50 in turn receives and sends the result of the determination to the information center server 10.

The communication network N is, for example, a WAN (Wide Area Network), but may include a LAN (Local Area Network) as well as telephone lines, private lines, cell phone communication networks, communication satellite networks, CATV (Cable Television) lines, and internet providers.

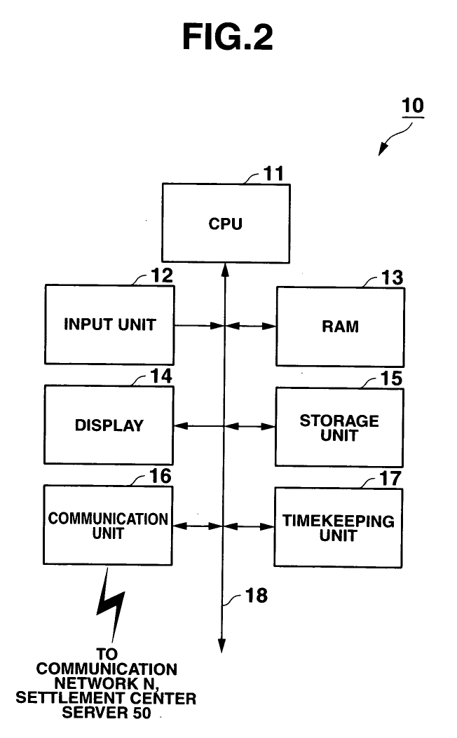

Then, referring to FIG. 2, the information center server 10 comprises a CPU (Central Processing Unit) 11 as a first control means, an input unit 12, a RAM (Random Access Memory) 13, a display 14, a first storage unit 15, a first communication unit 16 and a timekeeping unit 17, which are connected via a bus 18.

The CPU 11 is a functional core which controls the respective components of the information center server 10. The CPU 11 loads a system program and a specified one of various application programs stored in the storage unit 15 on the RAM 13 and performs various operations in cooperation with the program loaded in the RAM 13.

In electronic (or credit card) settlement, the CPU 11 cooperates with an information center server program, which is described later, to relay settlement data received from the ECRs 20A and 20B to the settlement center server 50, also relay the result of the determination of the approval request received from the settlement center server 50 back to the ECRs 20A and 20B and then store the result of the determination in the storage unit 15. Further, the CPU 11 cooperates with the information center server program to receive sales data from the ECRs 20A and 20B when these devices as the sales data processors terminate their daily task and then store the sales data in the storage unit 15. The CPU 11 also totals up the sales data and the settlement data and then creates a book credit management table 200 periodically at a request of the PCs 40A, 40B or the cell phone 70.

The input unit 12 comprises a keyboard with cursor keys, character keys and various other functional keys such that when one of the keys is depressed, a corresponding operation signal is outputted to the CPU 11. The input unit 12 may be a pointing device such as a mouse so as to send a signal indicative of its position to the CPU 11 when operated.

The RAM 13 is a volatile memory which has a working area where various programs to be executed/data on these programs are stored.

The display 14 comprises an LCD (Liquid Crystal Display) or a CRT (Cathode Ray Tube) on which a picture is displayed in accordance with a display control signal from the CPU 11.

The storage unit 15 is composed of a HDD (Hard Disk Drive) of a magnetic recording medium and stores various programs and data readably. The storage unit 15 stores therein sales data 100, book credit management table 200, settlement data in the settlement data storage unit 300 data, information center server programs, and decryption keys (not shown) corresponding to respective encryption keys (not shown) of the electronic settlement terminals 30A and 30B. These keys may be of a common key cryptosystem or of a public key cryptosystem.

The communication unit 16 comprises a modem, a TA (Terminal Adapter), a router, or a network card. The communication unit 16 communicates information with the settlement center server 50 and external units such as the ECRs 20A, 20B, and the PCs 40A, 40B on the communication network N connected thereto. The timekeeping unit 17 outputs information on a current date.

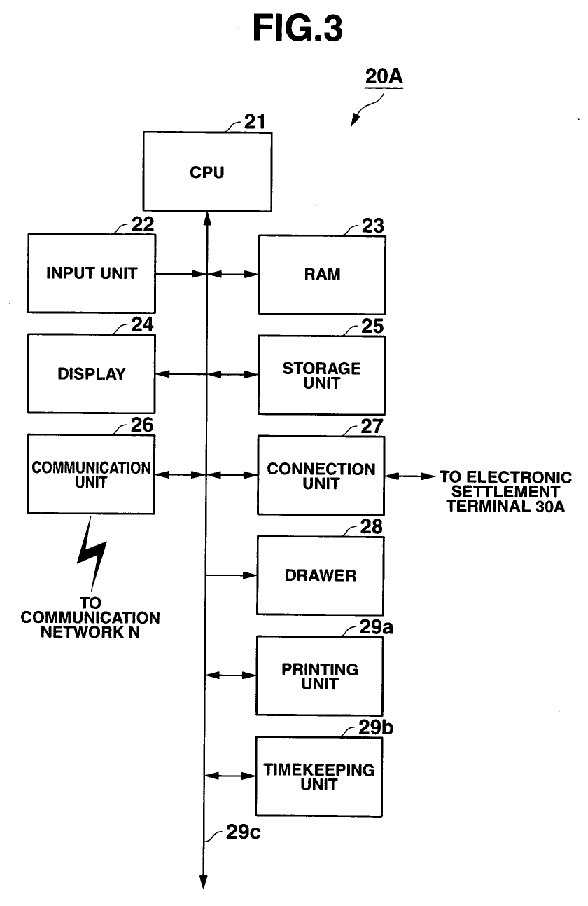

Then, referring to FIG. 3, the configuration of the ECR 20A is described as a representative example because the ECRs 20A and 20B have the same configuration.

As shown in FIG. 3, the ECR 20A comprises a CPU 21 as a second control means, an input unit 22, a RAM 23, a display 24, a storage unit 25, a communication unit 26, a connection unit 27, a drawer 28, a printing unit 29a, and a timekeeping unit 29b, which are connected to a bus 29c.

The CPU 21, RAM 23 and communication unit 26 are the same in configuration as the CPU 11, RAM 13 and communication unit 16, respectively, of the information center server 10 excluding several points, which will be mainly described below.

The CPU 21 cooperates with the ECR program stored in the storage unit 25 to process the sales data. When performing the electronic settlement, the CPU 21 receives encrypted settlement data from the terminals 30A and 30B, sends the data to the settlement center server 50, receives from the settlement center server 50 a result of determination as to whether the settlement should be approved, transfers the result of determination to the terminals 30A and 30B, and then stores the encrypted settlement data and the sales data in the storage unit 25. Further, when the CPU 21 cooperates with the ECR program to settle the sales transactions with cash or a credit card, it stores the sales data in the storage unit 15. The CPU 21 also cooperates with the ECR program to send the sales data to the settlement center server 50.

The input unit 22 comprises a register keyboard with cursor keys, character keys and other various functional keys such that when one of keys is depressed by the operator, a corresponding operation signal is outputted to the CPU 21. The display 24 comprises, for example, an LCD which displays a picture in accordance with a display control signal from the CPU 21. The input unit 22 may be composed of a touch panel integral with the display 24. The input unit 22 may comprise a barcode reader of the POS system.

The storage unit 25 comprises, for example, a ROM which has readably stored various programs and various data or a flash memory which can readably store various programs and various data. The storage unit 25 may comprise a HDD. Further, the storage unit 25 stores ECR identification numbers, sales data 90 and ECR programs.

The communication unit 26 communicates with external devices such as the information center server 10 on the communication network N. The connection unit 27 is communicably connected to the electronic settlement terminal 30A by a cable or wirelessly to send/receive information to/from the terminal 30A. The communication unit 27 of the ECR 20B is communicably connected to the terminal 30B.

The drawer 28 is for putting cash therein, and opens itself, for example, in accordance with a command from the CPU 21.

The printing unit 29a comprises, for example, a thermal printer with a roll of paper for a receipt or journal on which data such as an amount of money is printed out in accordance with a command from the CPU 21. The timekeeping unit 29b outputs data on a current date.

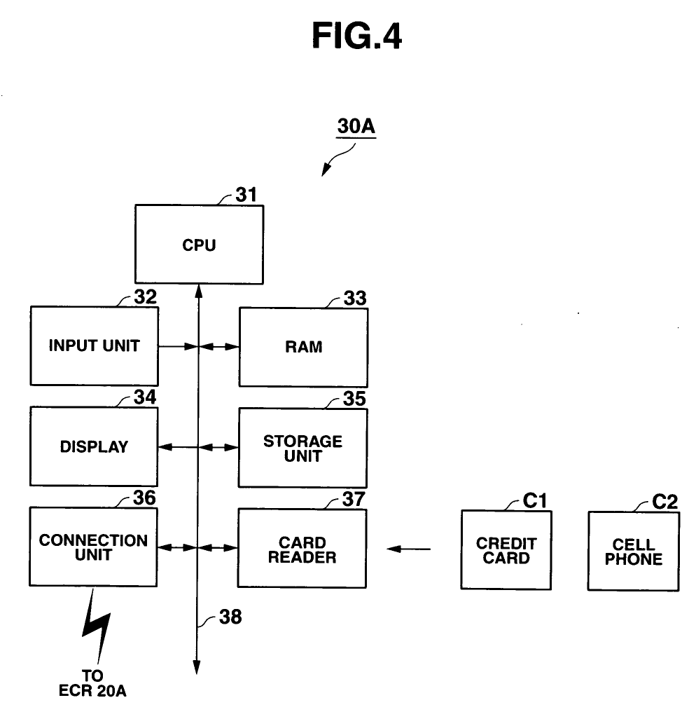

Referring to FIG. 4, the configuration of the electronic settlement terminals 30A is described as a representative example because the terminals 30A and 30B are the same in configuration and function.

As shown in FIG. 4, the terminal 30A comprises a CPU 31, an input unit 32, a RAM 33, a display 34, a storage unit 35, a connection unit 36, and a card reader 37, which are connected to a bus 38.

The CPU 31, RAM 33 storage unit 35, and connection unit 36 are the same in configuration as the CPU 21, RAM 23, storage unit 25, and connection unit 27, respectively, of the ECR 20A excluding several points, which will be mainly described below.

In electronic settlement, the CPU 31 cooperates with the electronic settlement terminal program stored in the storage unit 35 to read card information, encrypt the settlement data, send this data to the ECRs 20A, 20B, receive a result of determination as to whether the settlement should be approved from the ECRs 20A, 20B, and store the result of determination and the encrypted settlement data in the storage unit 35.

The input unit 32 comprises a keypad with numeric keys and other various functional keys such that when one of the keys is depressed by the operator, it outputs a corresponding operation signal to the CPU 31. The input unit 32 may comprise a touch panel integral with the display 34.

The storage unit 35 has stored an identification number for the electronic settlement terminal, an electronic settlement terminal program, and an encryption key corresponding to one of the decryption keys of the information center 10.

The connection unit 36 is communicably connected to the ECR 20A by a cable or wirelessly to transmit/receive information to/from the ECR 20A. The connection unit 36 of the electronic settlement terminal 30B is communicably connected to the ECR 20B.

The card reader 37 comprises a CPU, a RAM, a ROM, a flash memory, an information reader, which are not shown. In the card reader 37, the CPU and a program read from the ROM and loaded on the RAM cooperate to perform various operations. The information reader reads information on a credit card C1 or cell phone C2 connected thereto in a contact or non-contact manner.

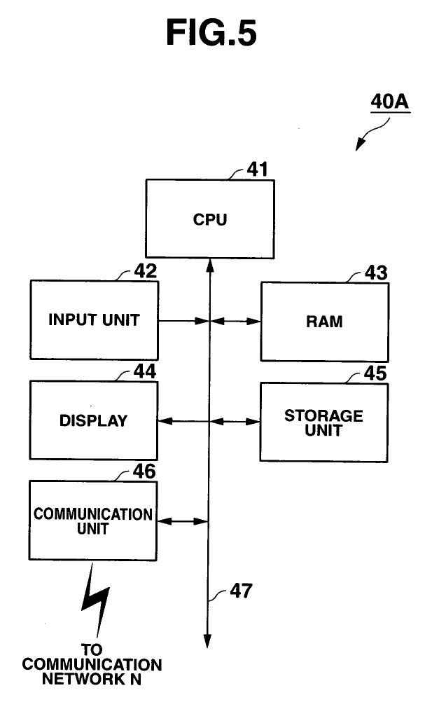

Referring to FIG. 5, the configuration of the PCs 40A and 40B is described. In this case, since the PCs 40A and 40B are the same in configuration, the internal configuration of the PC 40A is described as a representative example.

As shown in FIG. 5, the PC 40A comprises a CPU 41, an input unit 42, a RAM 43, a display 44, a storage unit 45 and a communication unit 46 which are connected to a bus 47.

The CUP 41, input unit 42, RAM 43, display 44, storage unit 45 and communication unit 46 are the same in configuration as the CUP 11, input unit 12, RAM 13, display 14, storage unit 15 and communication unit 16, respectively, of the information center server 10 excluding several points which will be mainly described below.

When receiving a sales data totalization request via the input unit 42, the CPU 41 cooperates with an access program stored in the storage unit 45 to send this request to the information center server 10, and receive totaled-up results of the sales data from the information center server 10, displays them on the display 44, and then stores them in the storage unit 45. Also, when receiving a settlement data totalization request from the input unit 42, the CPU 41 cooperates with the access program to send this request to the information center server 10, receives totaled-up results of the settlement data from the information center server 10, displays them on the display 44, and then stores them in the storage unit 45.

The communication unit 16 communicates with external devices such as the information center server 10 on the communication network N.

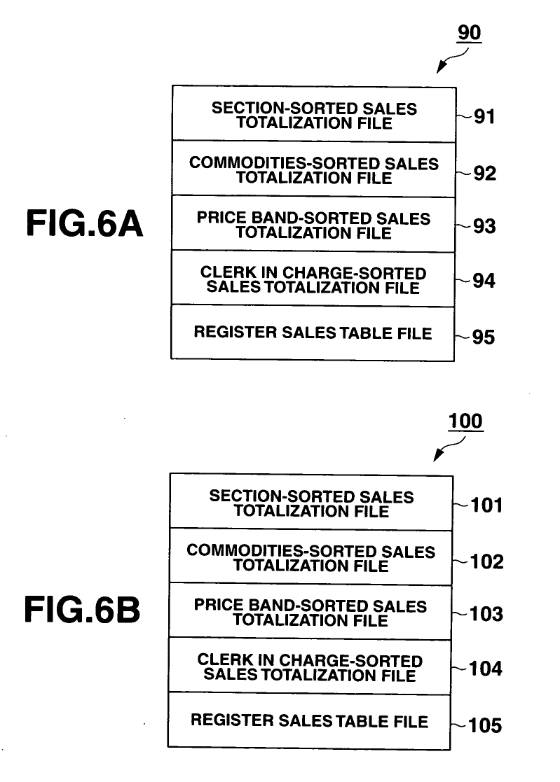

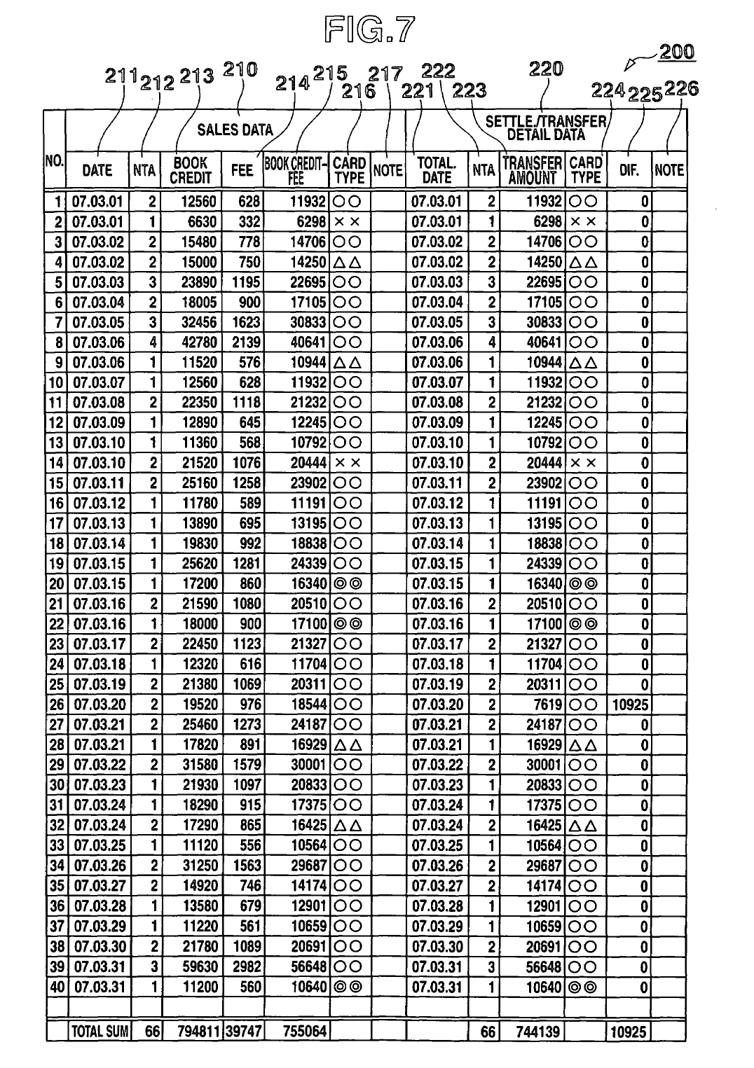

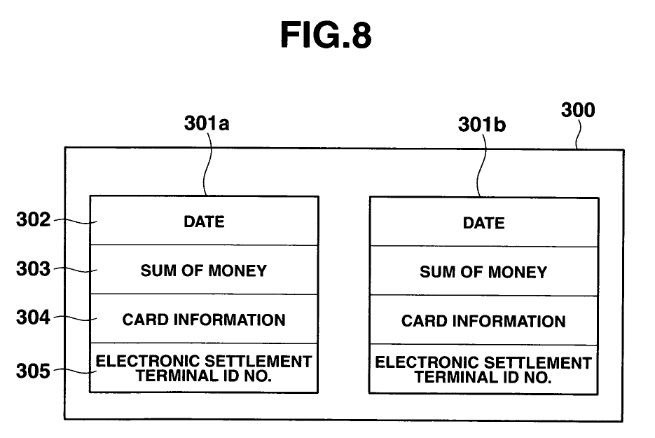

Then, referring to FIGS. 6-8, data to be processed by the settlement system 1 is described. FIGS. 6A and 6B illustrate the structures of sales data 90 and 100 stored in the ECR 20A and the information center server 10, respectively. FIG. 7 shows the structure of a credit sales management table 200 stored in the information center server 10. FIG. 8 shows the structure of a settlement data storage unit 300 stored in the information center server 10.

Each time a customer pays for the commodities which he or she purchased in a respective one of the stores where the ECRs 20A and 20B are set up, the ECR concerned stores in the storage unit 25 corresponding sales data 90, inputted by a store clerk in charge via the input unit 22 thereof, in an updating manner. Then, the ECR sends each day's sale data 90 stored in the storage unit 25 to the information center server 10 when the day's business ends.

The information center server 10 updates sales data 100 in the storage unit 15 with the day's sales data 90 received from each of the ECRs 20A and 20B. Assume that the daily sales data is for one generation. Then, the sales data 90 stored in the storage unit 25 comprises sales data, for example, for three generations (i.e., for a current day, the previous day and the day before the previous day), which data are updated every day in a first-in first-out manner.

As shown in FIG. 6A, the sales data 90 stored in the storage unit 25 of the ECR 20A involves a section-sorted sales totalization file 91, a commodity-sorted sales totalization file 92, a price band-sorted sales totalization file 93, a clerk in charge-sorted sales totalization file 94 and a register sales table file 95.

The types of data items to be inputted or used in the ECR 20A in each accounting operation include sales date (and time), item, number of customers, section, commodity name, number of commodities, unit price, subtotal, clerk in charge, and card type.

The “item” includes two types of subitems, i.e., actual sales result and transact key. The subitem “actual sales result” involves (daily) total sales volume, cash balance, amount of stock of gift certificates, amount of stock of credits, change provision, consumption tax, sales volume, and corresponding amount of consumption tax. The subitem “transact key” mainly involves three keys provided in the input unit 22, i.e., cash, gift certificate and credit card settlement keys each indicative of a respective one of the types of transactions. In each settlement, a corresponding key is depressed by the store clerk in charge. When the subitem is “transact key”, it indicates the type of key.

The “number of customers” indicates one involved in each account settlement. The “section” involves a department for commodity classification. When the section involves, for example, food and drink and more particularly, orange juice AA and tea BB, respectively, both belong to the section “drink”. The “subtotal” involves sales proceeds (the number of commodities×their unit price), and amount of consumption tax. The “store clerk in charge” indicates ID information indicative of a store clerk who actually operated the ECR 20A in the settlement. The “card type” involves information to identify a credit card company which settled the sales transactions involved, using its credit card.

The section-sorted sales totalization file 91 comprises a collection and total of proceeds of sold commodities of respective sections and a total of the number of those sold commodities of the respective sections, created based on the recorded data under corresponding ones of the above-mentioned data items. The commodity-sorted sales totalization file 92 comprises a collection and total of proceeds of sold commodities of respective types and a collection and total of the numbers of those sold commodities of the respective types, created based on the records under corresponding ones of the above-mentioned data items. The price band-sorted sales totalization file 93 comprises a collection and total of proceeds of sold commodities of respective price bands and a collection and total of the numbers of those sold commodities of the respective price bands, created based on the records under corresponding ones of the above-mentioned data items.

The register sales table file 95 comprises a collection and total of proceeds of sold commodities of respective types sorted by item (i.e., credit amount, cash balance or transact key) and a collection and total of the numbers of those sold commodities of the respective types, created based on the records under that item. The respective files for the sales data 90 are updated each time the sales transaction is settled and also every day.

As shown in FIG. 6B, the sales data 100 stored in the storage unit 15 of the information center 10 involves a section-sorted sales toralization file 101, a commodity-sorted sales toralization file 102, a price band-sorted sales toralization file 103, a clerk in charge-sorted sales toralization file 104 and a register sales table file 105.

In each of the files 101-105, the sales data are sorted by ECR identification number so as to allow to know the respective ECRs which handled those sorted data.

In the information center server 10, a credit sales management table 200 for the credit card settlement is created and stored (or updated) in the storage unit 15, as is described later. As shown in FIG. 7, the credit sales management table 200 comprises a sales data item 210 and a settlement/transfer detail data item 220. The sales data item 210 is one involving the electronic settlements performed. The settlement/transfer detail data item 220 involves transfer of an amount of money for the book credit from the management company of the information center server 10 to the store's or owner's account concerned in the electronic settlement.

The sales data item 210 comprises subitems which are date 211, number of times of settlement performed based on the sales data (NTA) 212, book credit 213, fee 214, (book credit−fee) 215, card type 216, and note 217. The (book credit−fee) 215 is book credit 213−fee 214. The sales data 210 contains records under two main key items which are date 211 and card type 216.

The settlement/transfer detail data item 220 comprises data subitems which are totalization date 221, number of times the account for the sales data was settled (NTA) 222, transfer amount 223, card type 224, difference balance 225 and note 226. The totalization date 221 indicates a same date as the information center server 10 received the sales data. This date also is a same date as the commodities concerned were sold. The transfer amount 223 indicates an amount of money transferred from the management company of the information center server 10 to the store's or owner's bank account concerned. The balance 225 indicates a difference between the book credit 213 and the transfer amount 223.

When the electronic settlement terminal 30A or 30B electronically settles the account for the customer, the information center server 10 receives encrypted settlement data from the ECR 20A or 20B, decrypts the data and then sends to the credit card company server 60. As shown in FIG. 8, the information center server 10 stores the encrypted settlement data as 301a or 301b in the settlement data storage section 300 of the storage unit 15.

The settlement data 301a and 301b each are obtained in a single electronic settlement operation. The settlement data 301a comprises items which are date 302 when the account was electronically settled, amount of money 303, card information 304, and electronic settlement terminal ID number 305 concerned. When each of the settlement data stored in the settlement data storage section 300 is used, the encrypted data is required to be read and decrypted. The card information 304 involves the card number and type.

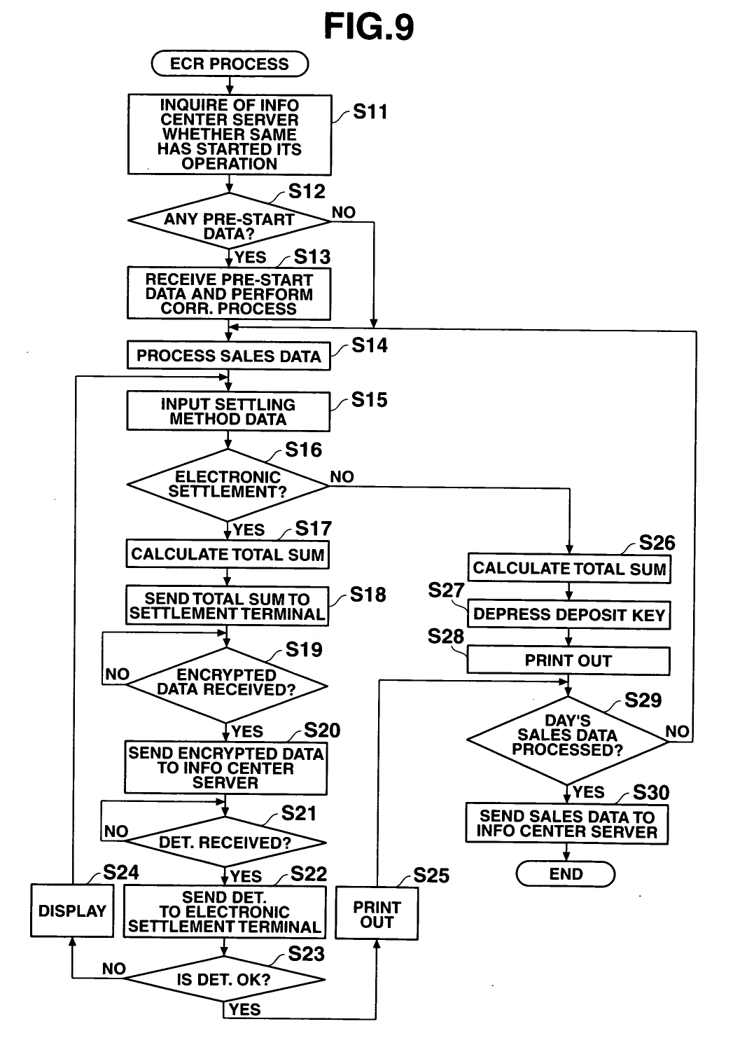

Referring to FIGS. 9-19, operation of the settlement system 1 is described. While in the following description, operation of the ECR 20A, electronic settlement terminal 30A and PC 40A is described as a representative example, operation of the ECR 20B, electronic settlement terminal 30B and PC 40B will be likewise performed.

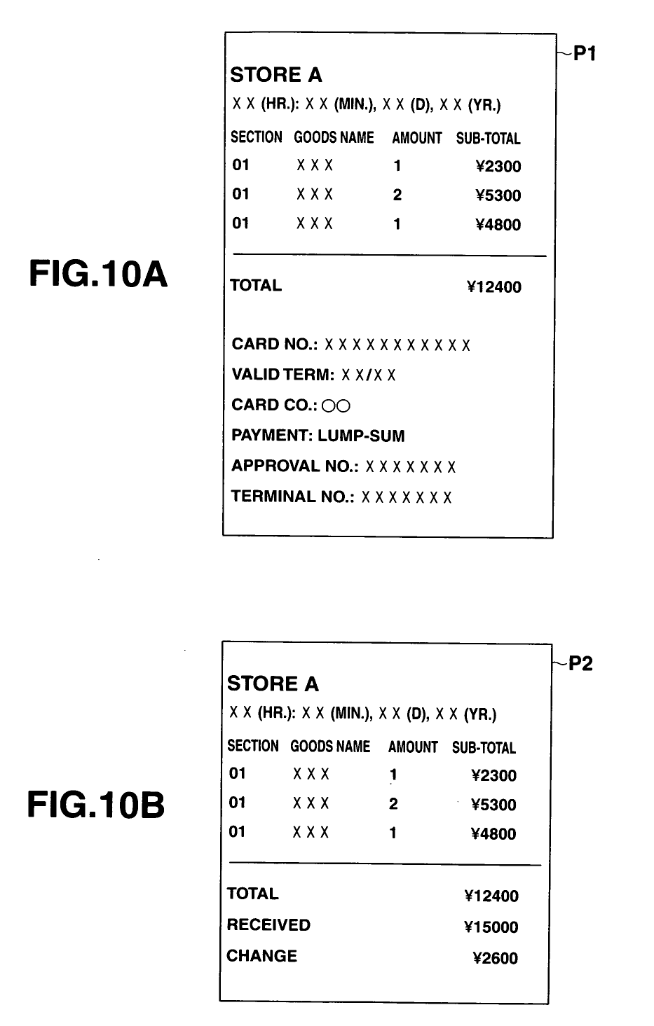

First, referring to FIGS. 9 and 10, an ECR operation of the ECR 20A is described. FIG. 9 shows a flow of the ECR operation of the ECR 20A. FIGS. 10A and 10B show receipts P1 and P2 for the electronic and cash settlements, respectively.

For example, before the store is opened, a power supply (not shown) of the ECR 20A is turned on. Then, when a command to operate the ECR 20A is given via the input unit 22 to the ECR 20A, an ECR program is read from the storage unit 25 and loaded on the RAM 23. The CPU 21 cooperates with this ECR program to perform its ECR operation.

First, the ECR 20A sends the information center server 10 an inquiry message as to whether the information center server 10 has opened (step S11). If so, the ECR 20A determines whether the information center server 10 has pre-start data which should be sent to the ECR 20A (step S12). The pre-start data involves a list of card numbers of unused or invalid credit cards to be handled at the start of the ECR operation. If so (YES in step S12), the ECR 20A receives the pre-start data from the information center server 10 and performs an operation involving the received pre-start data (step S13).

At this time, the ECR 20A sends this list to the electronic settlement terminal 30A and stores the list in its storage unit 35. Thus, unauthorized users can be checked, using the list of card numbers before sending an inquiry message about a user, if any, to the card company server 60.

Then, the ECR 20A receives data on the type and number of commodities which the customer purchases through the input unit 22 (step S14). If there is no pre-start data (NO in step S12), the process goes to step S14 where the transact key is depressed, indicating which of cash, gift certificates and credit card should be used for the settling purpose (step S15). More particularly, in the case of cash or gift certificates, a total key is depressed. In the electronic settlement, an electronic settlement key is depressed.

In the electronic settlement, ECR 20A determines whether the account should be settled electronically with the credit card C1 or cell phone C2 (step S16).

When the account should be settled electronically (YES in step S16), the ECR 20A calculates a total sum of money which should be charged for the sold commodities whose information was received in step S14, and then sends an electronic settlement request to the settlement terminal 30A (step S17). Then, in response to a request from the terminal 30A, the ECR 20A sends the calculated total sum of money to the terminal 30A (step S18).

Then, the ECR 20A determines whether encrypted settlement data is received from the terminal 30A (step S19). The encrypted settlement data comprises information on a customers' credit card C1 or cell phone C2 read by the terminal 30A, a (total) sum of money, a date and a terminal ID number, encrypted with the key of the terminal 30A. If no encrypted settlement data is received (NO in step S19), step S19 loops back to itself.

When the encrypted data is received (YES in step S19), it is sent to the information center server 10 (step S20). The information center server 10 in turn sends this data via the settlement center sever 50 to the card company server 60. The information center server 10 also receives a result of determination as to whether the settlement should be approved via the settlement center server 50 from the card company server 60 and then sends the result of determination to the ECR 20A. The result of determination comprises an approval number if the settlement is approved. Then, in the ECR 20A, it is determined whether the result of determination is received from the information center server 10 (step S21). If not (NO in step S21), the step S21 loops back to itself.

When receiving the result of determination (YES in step S21), the ECR 20A sends it to the terminal 30A (step S22). Then, the ECR 20A acquires the result of determination from the settlement terminal 30A and then determines whether the result of determination and the card information indicate approval (step S23). If the result of determination indicates disapproval (NO in step S23), the ECR 20A displays on the display 24 a message that the settlement cannot be approved (step S24) and then returns to step S15.

When the result of determination indicates that the settlement is approved (YES in step S23), the account is settled electronically based on the transaction data and the printing unit 29a prints out the result of determination on a receipt sheet. Then, the sales data 90 in the storage unit 25 is updated with the sales data involving the settlement with card (step S25). Then, the store clerk hands the receipt over to the customer. The receipt contains usual print information on the date, commodity name, section, number of commodities, subtotal and total sum of money. The receipt also contains card number, card type (or card company name), valid term, payment method, approval number, and electronic settlement terminal ID number (or terminal number) printed thereon. The payment method comprises payment in a lump sum or installments. The receipt is, for example, as shown by P1 in FIG. 10A. The electronic settlement terminal ID number is acquired, for example, from the terminal 30A.

When the electronic settlement is not used (NO in step S16), the settlement is performed with cash or gift certificates. Thus, a total charge for purchased commodities for a settling purpose is calculated (step S26). Thus, the store clerk in charge receives a corresponding amount of cash or gift certificates from the customer. Then, when the store clerk inputs data on the received amount of cash or gift certificates into the input unit 22 and depresses a deposit key (not shown), the drawer 28 is opened (step S27). The store clerk puts the received amount of cash or gift certificates in the drawer 28 and then hands changes over to the customer.

Then, the sales data 90 stored in the storage unit 25 is updated with the sales data involving the settlement with the cash or gift certificates and result of the settlement are printed out by the printing unit 29a on a receipt sheet (step S28). The receipt is then handed by the store clerk over to the customer. The content of the receipt involves one obtained with usual cash settlement. For example, the receipt is printed as shown by P2 in FIG. 10B.

After the operation in step S25 or S28, a time provided by the timekeeping unit 29b is acquired and it is determined whether the current time is when the day's sales data process should be terminated (step S29). Alternatively, the arrangement may be such that the store clerk gives a command to terminate the sales data process to the ECR 20A. If not (NO in step S29), the process goes to step S14. If the time is when the sales data process should be terminated (YES in step S29), the ECR ID number and the sales data stored in the storage unit 25 are sent to the information center server 10 (step S30) and then the ECR operation is terminated.

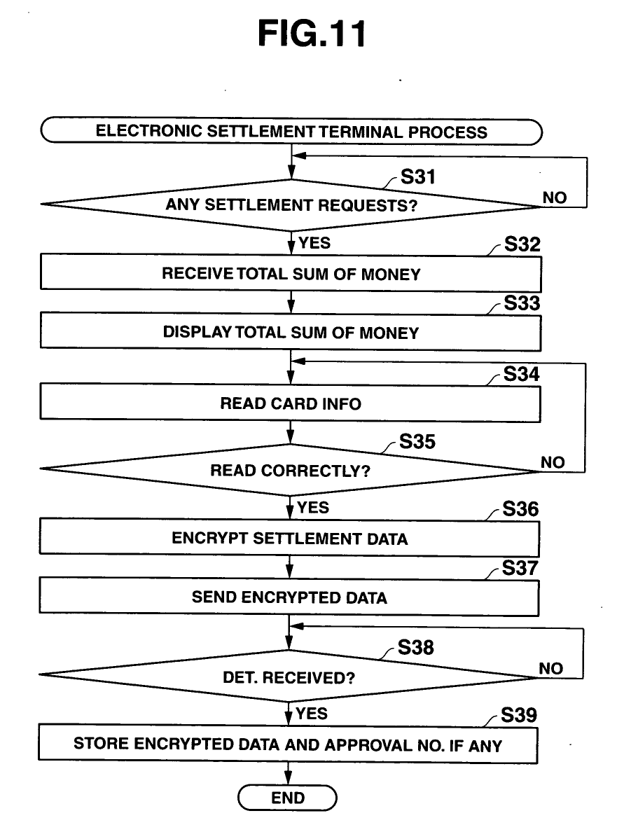

Then, referring to FIG. 11, the electronic settlement process to be performed by the electronic settlement terminal 30A is described.

Assume, for example, that a power source (not shown) for the terminal 30A is turned on before the store is opened. Then, when a command to perform an electronic settlement operation at the terminal 30A is inputted via the input unit 32 to the terminal 30A, the CPU 31 cooperates with the electronic settlement terminal program loaded from the storage unit 35 on the RAM 33 to perform the electronic settlement operation.

First, in the electronic settlement terminal 30A, it is determined whether an electronic settlement request is received from the ECR 20A (step S31). If not (NO in step S31), the process goes to step S31. If the request is received (YES in step S31), a request for a total charge for the sold commodities is sent to the ECR 20A in correspondence to the step S18 of the ECR operation and then a total sum of money for the commodities is received from the ECR 20A (step S32). At this time, data on the current date is also acquired along with the total amount of money from the ECR 20A.

Then, the total sum of money received in step S32 is displayed on the display 34 (step S33). Then, card information on the customer's credit card C1 or cell phone C2 is read by the card reader 37 (step S34). The card information comprises the card number and valid card term. Then, it is determined whether the card information is read correctly (step S35). If not (NO in step S35), the process goes to step S34.

Then, settlement data is produced which comprises the card information, date, total charge, and setting terminal ID number stored beforehand in the storage unit 35. The data is then encrypted with the key stored in the storage unit 35, thereby producing encrypted settlement data (step S36).

Then, the encrypted settlement data is sent to the ECR 20A (step S37). Then, it is determined whether a result of determination as to whether the settlement concerned should be approved is received from the ECR 20A in correspondence to the step S21 of the ECR operation (step S38). If not (NO in step S38), the process goes to step S38.

When the result of determination is received from the ECR 20A (YES in step S38), the result of determination and the card information are sent to the ECR 20A and the encrypted settlement data is stored or tanked in the storage unit 35 in correspondence to the result of determination (or along with an approval number, if any) (step S39). Thus, the terminal 30A terminates the settling operation.

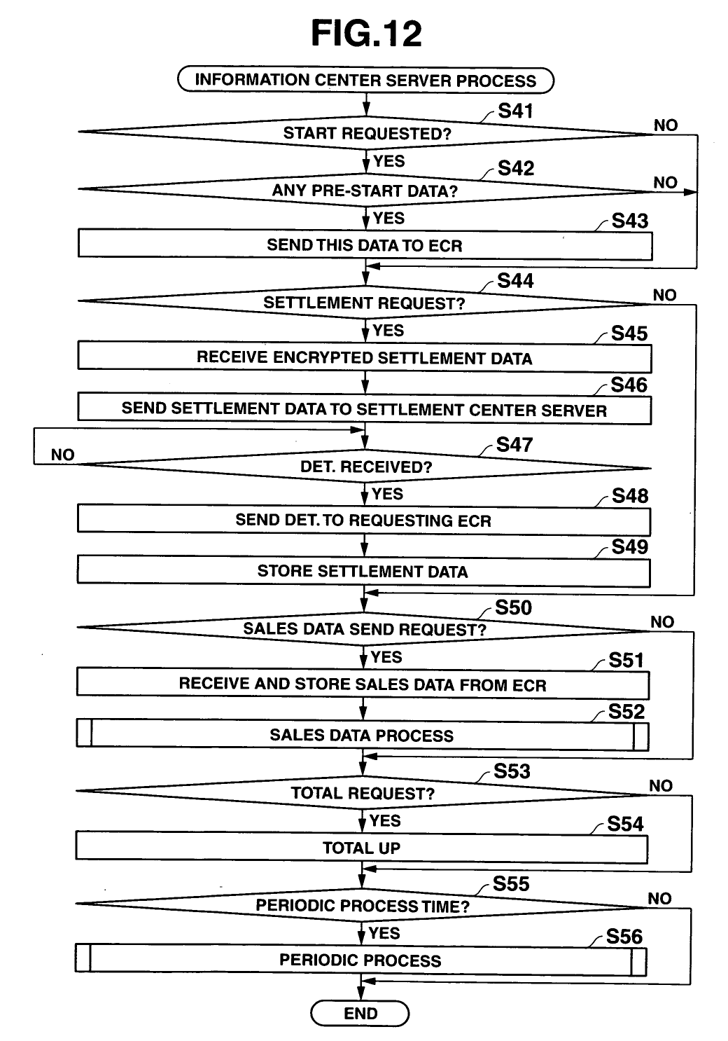

Then, referring to FIG. 12, a flow of operation of the information center server 10 is described.

This operation is repeated periodically in the information center server 10. For example, when a time when the information center server 10 should start its operation comes, the CPU 11 reads an information center server program from the storage unit 15 and loads it on the RAM 13 to perform the information center server operation.

First, in correspondence to the step S11 of the ECR operation, it is determined whether a start request is received from the ECR 20A or 20B (step S41). If so (YES in step S41), it is then determined whether there is pre-start data to be sent to the requesting ECR (step S42). If so (YES in step S42), this data is then sent to the requesting ECR (step S43).

Then, in correspondence to the step S20 of the ECR operation, it is determined whether a settlement request is received from the ECR 20A or 20B (step S44). If not (NO in step S41) or there is no pre-start data (NO in step S42), the process goes to step S44. If so (YES in step S44), the encrypted settlement data is received from the requesting ECR (step S45). Then, the encrypted settlement data is decrypted with the corresponding decryption key stored beforehand in the storage unit 15 and then sent as decrypted settlement data to the settlement center 50 (step S46). The decrypted settlement data is then sent from the settlement center 50 to a corresponding card company server 60.

Then, it is determined in the information center 10 whether a result of determination as to whether the settlement concerned should be approved is received from the settlement center server 50 (step S47). If so (YES in step S47), the result of determination is sent to the requesting ECR (step S48). Then, the encrypted settlement data is stored in the data storage section 300 of the storage unit 35 in association with the result of determination (or along with an approval number) (step S49).

Then, in correspondence to the step S30 of the ECR operation, it is determined whether a request for sending the sales data to the information center server 10 has been received from the ECR 20A or 20B (or whether reception of the sales data has been started) (step S50). If not (NO in step S44), the process goes to step S50. When the request for sending the sales data has been received (YES in step S50), the reception of the sales data from the requesting ECR is terminated and then the sales data is stored in the storage unit 5 (step S51). More specifically, the day's sales data received is stored as sales data 100 in the storage unit 15, or updates the data stored in the storage unit 25.

Then, a sales data processing operation to be described in more detail later is performed (step S52). Then, it is determined whether a totalization request is received from the PC 40A or 40B (step S53). If not (NO in step S53), the process goes to step S53. If so (YES in step S53), the sales data is totaled up (step S54).

In the totaling-up operation, first, the information center server receives a log-in request from the PC 40A, 40B or cell phone 70 and a communication link is established in a log-in operation between the information center server 10 and the requesting PC 40A or 40B or cell phone 70. When a request for totaling up the sales data is received from the logging-in device, the sales data 100 stored in the storage unit 15 is totaled up depending on the content of the request and then the totaled-up results are sent to the requesting device. When a request for totaling up the settlement data is received from the logging-in device, the settlement data stored in the settlement data storage section 300 of the storage unit 15 are totaled up and then the totaled-up results are sent to the requesting device.

Then, it is determined whether the current date provided by the timekeeping unit 17 indicates a time when a periodic process to be described later should be performed (step S55). While the periodic process is illustrated as performed once a day, it is not limited to this example.

When no totalization request is received (NO in step S53), the process goes to step S55. When a time when the periodic process should be made has come (YES in step S55), the periodic process is performed (step S56), thereby terminating the information center server operation. If not (NO in step S55), the information center server operation is terminated likewise.

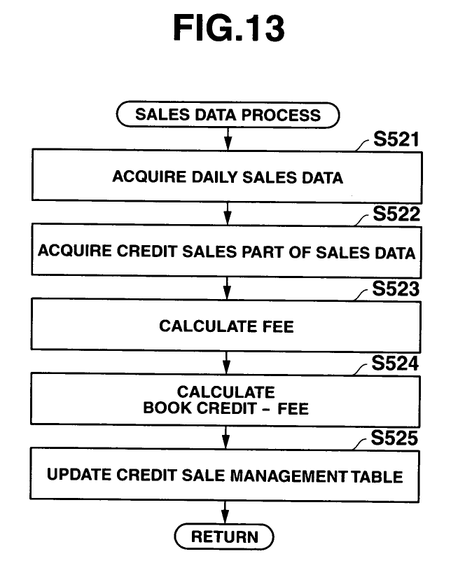

Then, referring to FIG. 13, the sales data processing in step S52 of the information center server operation is described. FIG. 13 shows a flow of the sales data processing by the information center server.

First, sales data for one day is read from the sales data 100 stored in the storage unit 15 (step S521). Then, records under subitems composing an item “credit card sales” are extracted from the read sales data (step S522). The subitems include “sales date” for the commodities, “book credit” for this sales, “card type” used and “NTA” which means the number of times the account was settled in the sales of that day.

A fee rate preset in correspondence to the card type acquired in step S522 is read from the storage unit 15 and then a fee is calculated for the book credit acquired in step S522, using the fee rate (step S523). For example, if the fee rate is 5%, the fee is 0.05× the book credit. Then, the book credit−(minus) the fee is calculated (step S524).

Then, data on the date, NTA, book credit, fee, (book credit−fee), and card type acquired/calculated in steps S522-S524 are additionally recorded along with a note under corresponding subitems 211, 212, 213, 214, 215, 216 and 217, respectively, of the book credit management table 200 (FIG. 7) in the storage unit 15 (step S525).

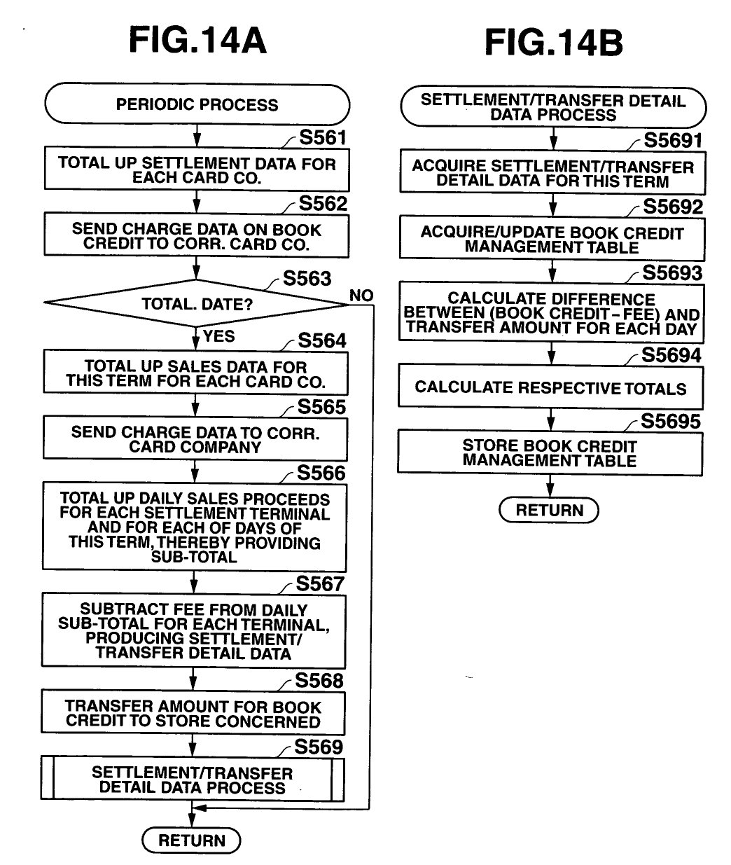

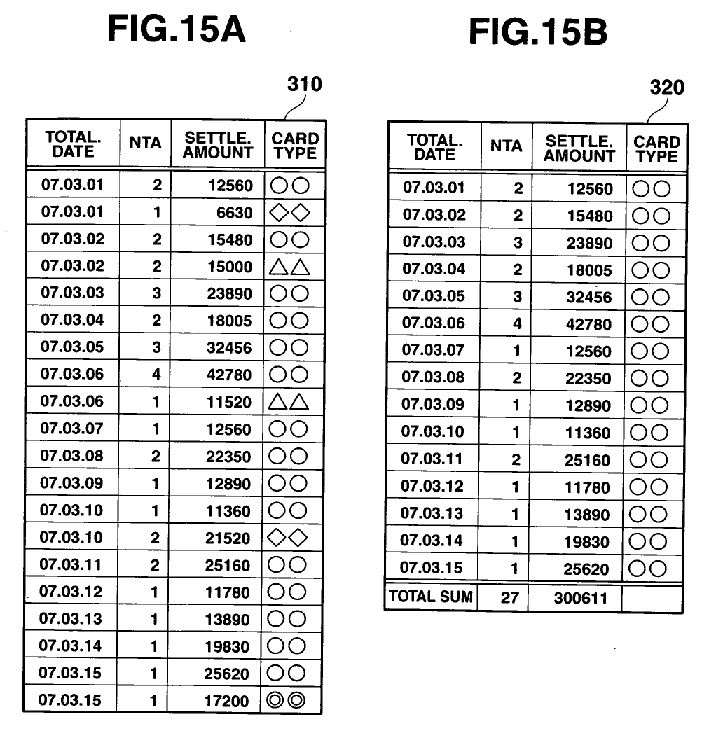

Then, referring to FIGS. 14 and 15, the periodic operation to be performed in the step S56 of the information center server process is described. FIG. 14 shows a flow of the periodic process in the information center server.

First, respective settlement data stored in the settlement data storage section 300 of the storage unit 15 and then respective card types included in card information 304 are referenced, the settlement data for each card company are totaled up, and then stored in the storage unit 15 (step S561). Thus, for example, as shown in FIG. 15A, settlement data for the respective (totalization) dates and card types based on the settlement data stored in the settlement data storage section 300 are collected or aggregated, and as a result, a settlement data table 310 is formed.

Then, charge data on a book credit for each company is created based on the collected results for that card company in step S561 and sent via the settlement center server 50 to the server 60 of that card company, thereby charging for the total amount of book credit (step S562).

Then, it is determined whether the current date data provided by the timekeeping unit 17 indicates a preset totalization date (step S563). If so (YES in step S563), the card type for each company is referenced and all the sales proceeds for that company and for this settlement term (ranging from the date after the last totalization date to this totalization date) are extracted from the collected results, stored in the storage unit 15, for example as shown in FIG. 15A, and then totaled up and stored as a total sum in the storage unit 15 (step S564). Thus, for example, as shown in FIG. 15B, a settlement data table 320 which comprises (totalization) dates of this settlement term and corresponding records under the same card type, and a total sum is created as the collected results.

Then, charge data for the total sum is created for each card company based on the collected results for that company obtained in step S564 and is then sent via the settlement center server 50 to that card company server 60, thereby charging for the total sum of the proceeds for this settlement term. (step S565).

Then, the ID number of each of the settlement terminals is referenced and the proceeds for that terminal and for each of the days of this settlement term are extracted from the settlement data stored in the settlement data storage section 300 and totaled up and stored as a subtotal in the storage unit 15 (step S566). Then, a fee is subtracted from each such subtotal. Then, these resulting data are collected, thereby creating settlement/transfer detail data (step S567). This detail data involves items (for the settlement term) which include “date”, “transfer amount of money” (=subtotal−fee) and “card type” under which subitems corresponding daily records are listed with a total sum of the transfer amounts of money. This data is printed out and mailed as a detailed transfer statement by post to a store concerned.

Then, an operation for transferring the total sum of the amounts of money for the total book credit to the account of that store is performed based on the settlement/transfer detail data obtained in step S567 (step S568). For example, transfer command data to transfer a total sum of money for a book credit from the account of the managing company of the information center server 10 to the account of that store is created and then sent to a server of a financial institution concerned (not shown).

Then, a settlement/transfer detail data processing operation which is described later is performed (step S569), thereby terminating the periodic process. When a next totalization date has not come yet (NO in step S563), the periodic process is terminated.

As shown in FIG. 14B, in the settlement/transfer detail data process, first, settlement/transfer detail data involving this settlement term are read from the storage unit 15 (step S5691). Then, the book credit management table 200 involving the settlement term also is read from the storage unit 15, and the number of times the account was settled (NTA) on each of the dates involving the settlement/transfer detail data is counted. Thus, record data on date, NTA, transfer amount, card type and note are stored under corresponding similar-named items 221, 222, 223, 224 and 226, respectively, in the acquired book credit management table 200 (in FIG. 7) (step S5692).

Then, in the book credit management table 200, a difference between (book credit−fee) 215 and transfer amount 223 for each date is calculated and stored under subitem “difference 225” of the book credit management table 200 (step S5693). Then, all the record data for the respective dates of the term involving each of the number of times which the account was settled (NTA) 212, book credit 213, fee 214, (book credit−fee) 215, NTA 222, transfer amount 223, and difference 225 are totaled up and stored in the corresponding lowermost columns of the book credit management table 200 (FIG. 7) (step S5694).

Then, the book credit management table 200 created in steps S5691-5694 is stored in the storage unit 15 (step S5695), thereby terminating the settlement/transfer detail data creating operation.

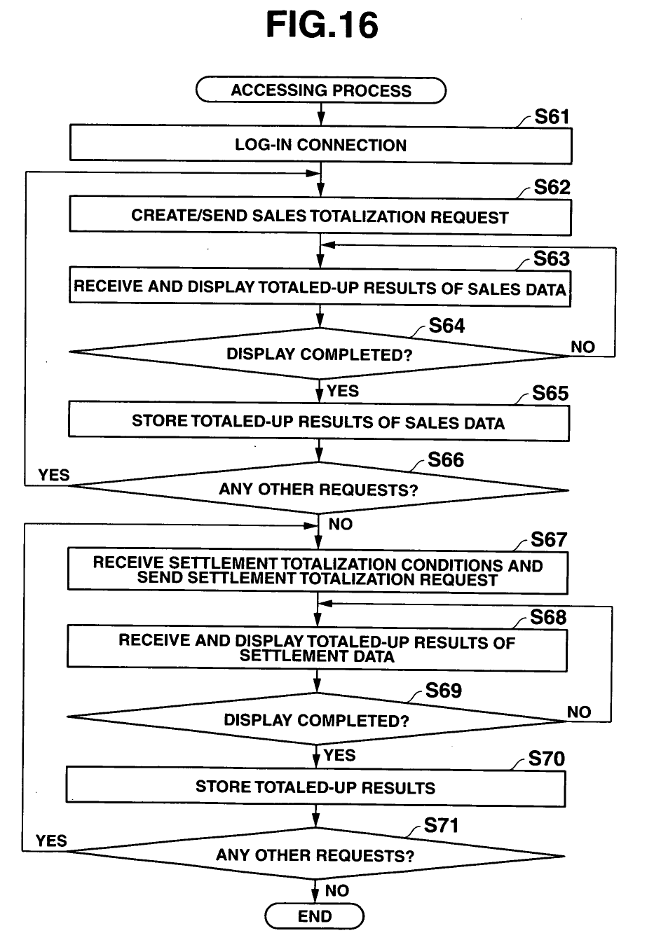

Then, referring to FIG. 16, an accessing process is described which will be performed in the PC 40A, 40B or cell phone 70 in correspondence to the totaling operation in the step S54 of the information center server process. Here, operation of the PC 40A is described as a representative example.

When the PC 40A receives a command to perform the accessing process, for example, via the input unit 42 from the user or owner, the CPU 41 cooperates with an accessing program loaded from the storage unit 45 on the RAM 43 to perform the accessing process.

First, a log-in connection request is sent from the PC 40A to the information center server 10. Then, information required for the log-in connection is received via the input unit 42 (FIG. 5) by the PC 40A, and then sent to the information center server 10. When this information is approved by the server 10, the log-in connection is made to the information center server 10 (step S61).

Then, conditions for sales data totalization are received via the input unit 42 from the user. Then, a sales data totalization request including those conditions is created and sent to the information center server 10 (step S62). The sales totalization request comprises the conditions for the totalization, collection and analysis of the sales data 100.

Then, totaled-up results of the sales data in response to the sales totalization request are received from the information center server 10 and displayed on the display 44 (step S63). Then, it is determined whether the display of the totaled-up results of the sales data in step S63 has been completed (step S64). If not (NO in step S64), the process goes to step S63.

When the display of the totaled-up results has been completed (YES in step S64), the totaled-up results are stored in the storage unit 45 (step S65). If not (NO in step S64), the process returns to step S63 (step S65). Then, it is determined, for example, based on an input received via the input unit 42 from the user whether another sales data totalization request has been received (step S66). If so (YES in step S66), the process goes to step S62.

When no other sales data totalization request is received (NO in step S66), conditions for settlement data totalization are received via the input unit 42. Then, a settlement data totaling request including the conditions is created and then sent to the information center server 10 (step S67). The settlement totalization request includes the conditions for totalization and analysis of the settlement data stored in the settlement data storage unit 300.

Then, totaled-up results of the settlement data in response to the settlement data totalization request are received from the information center server 10 and then displayed on the display unit 44 (step S68). It is then determined whether the display of the totaled-up results of the settlement data in step S68 has been completed (step S69). If not (NO in step S69), the process returns to step S68.

When the display of the totaled-up results of settlement data has been completed (YES in step S69), the totaled-up results are stored in the storage unit 45 (step S70). Then, it is determined based on inputs, if any, from the user via the input unit 42 whether another settlement data totalization request has been received (step S71). If so (YES in step S71), the process goes to step S67. If not (NO in step S71), the accessing process is terminated.

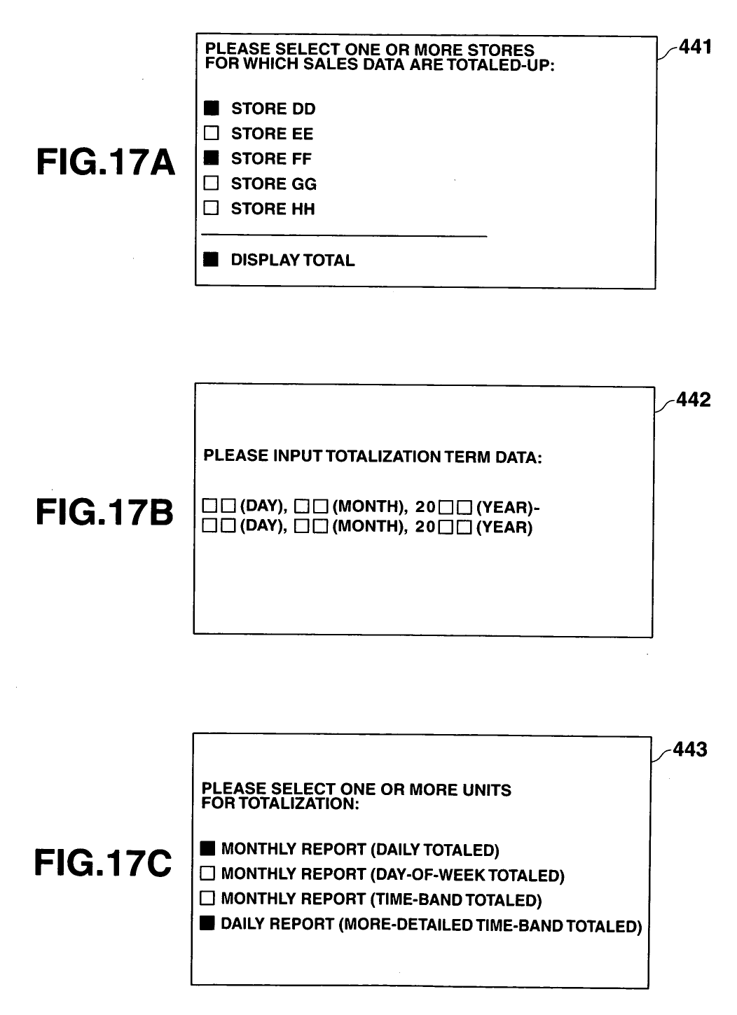

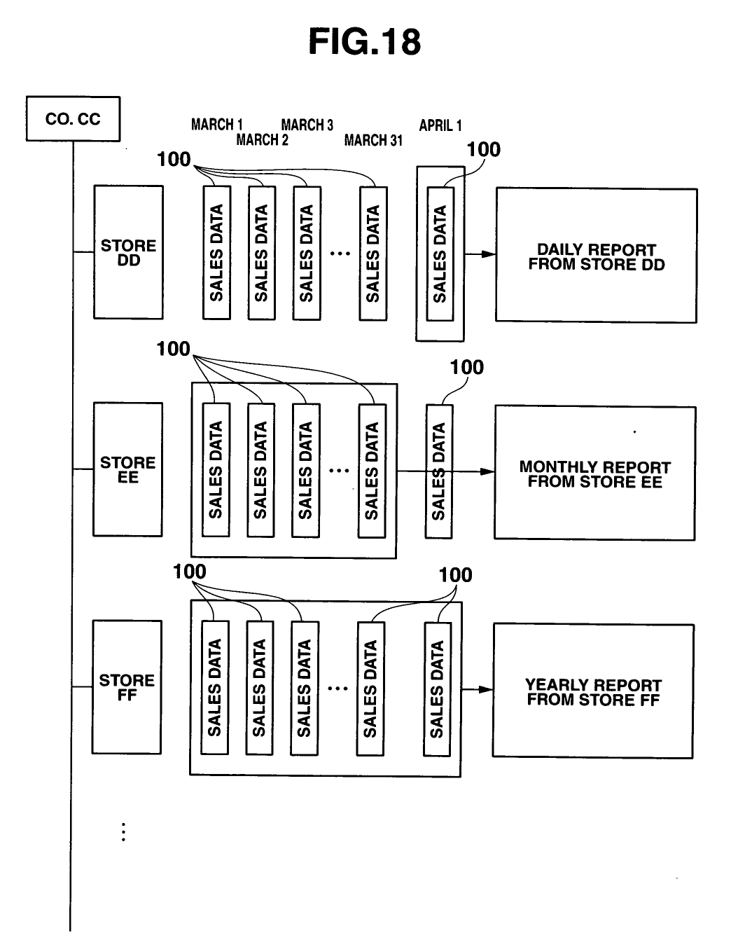

Then, referring to FIGS. 17-19, a specified example of the totaling-up process to be performed in the information center server 10 at a request of an accessing terminal such as the PC 40A is described. FIG. 18 shows several examples of a range of sales data to be totaled up.

In steps S62 and S67 of the accessing process (FIG. 16), for example, input pictures 441-443 of FIGS. 17A-C involving totalization of the sales data or settlement data are displayed on the PC 40A and condition data for totalization of the sales data or settlement data are input to the pictures from the input unit 42. On the input picture 441, one or more of stores DD-HH whose sales data or settlement data should be totaled up are selectable by checking off corresponding one or more check boxes. Also, on the input picture 441, whether a total sum of the proceeds for all the stores should be displayed is selectable by checking off a corresponding check box.

On the input picture 442, data on a settlement term for which the sales data are totaled up are inputtable. On the input picture 443, one or more of collecting conditions: i.e., monthly report (daily totaled), monthly report (day-of-week totaled), monthly report (time-band totaled), and daily report (time-band and another type totaled) are selectable by checking off corresponding one more check boxes. The collecting condition “monthly report (daily totaled)” means that the sales data should be totaled up every day for one month and their totaled-up results should be collectively reported as a monthly report once a month. The collecting condition “monthly report (day-of-week totaled)” means that the sales data should be totaled up every predetermined day of week for one month and their totaled-up results should be collectively reported as a monthly report once a month. Other collecting conditions should be understood similarly.

As shown in FIG. 18, setting inputs may be given such that, for example, for the store DD, the range of sales data to be totaled up should be only April 1 and the report should be daily; for the store EE, the range of sales data to be totaled up should be March and the report should be monthly; and for the store FF, the range of sales data to be totaled up should be this year and the report should be yearly. Each sales data of FIG. 18 is a daily one 100. The daily report should contain, for example, records on actual sales results, a transact key-sorted total sum, a balance (cash balance in the ECR), a section-sorted sales proceeds, and a time band-sorted number of commodities sold. These data are collectable and analyzable from these sales data 100.

The monthly reports contain, for example, records on a day-sorted sales data totalization table, a day of week-sorted sales data totalization table, a time band-sorted sales data totalization table, a section-sorted sales data totalization table, a commodity-sorted sales data totalization table, a price band-sorted sales data totalization table and a store clerk in charge-sorted sales data totalization table whose data are obtainable from the sales data 100. The yearly reports contain, for example, a monthly sales data totalization table and a last-this year sales data comparison table whose data are obtained from those sales data 100.

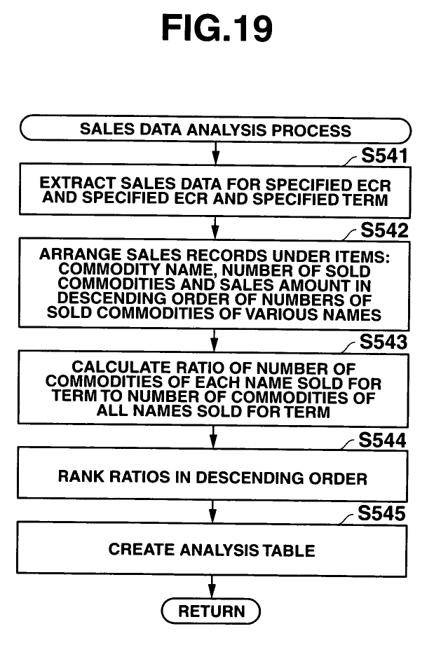

Referring to FIG. 19, a sales data analysis process is described as an example. This process composes a part of the totaling-up process in step S54 of the process (FIG. 12) to be performed in the information center server 10.

Consider, for example, analysis of ranking of the numbers of commodities of various names sold for a particular settlement term in a store of interest (or ECR). In the PC 40A concerned, data on the name of the store of interest, the settlement term and a command to make a ranking analysis are inputted to the input unit 42, thereby sending a sales data totalization request including the inputted data to the information center server 10.

In the information center server 10, first, the sales data totalization request is received. Then, referring to this request, sales data on commodities sold in the store (ECR) for the settlement term included in the request are extracted from the sales data 100 stored in the storage unit 15 (step S541). Then, the sales records falling under items “commodity names”, “number of commodities sold” and “sales amount” are arranged in descending order of the numbers of sold commodities of the various names (step S542).

Then, the total number of commodities of those names sold for that term is calculated. Then, a ratio of the number of commodities of each name sold for the term to the number of commodities of all those names sold for the term is calculated and then added as a record under an item “ratio in number” (step S543). Then, those respective ratios involving the numbers of sold commodities of those names are ranked as records in descending order under an item “rank” (step S544). For example, the top 10 of the numbers of sold commodities of those names should be handled as being in rank A, the next 11-25 as being in rank B and the remaining ones as being in rank C.

Then, all the records created in steps S541-544 are collected in the form of an analysis table which indicates a result of the analysis and then sent to the requesting PC 40A (step S545), thereby terminating the analysis process. Then, the analysis table is received by the PC 40A and displayed on its display 44.

As described above, according to the present embodiment, the information center server 10 relays the settlement data between the settlement center server 50 and each of the ECRs 20A and 20B; receives, stores and manages the sales data received from the ECRs 20A and 20B; and stores the settlement data and sales data 100 in the settlement data storage section 300 of the storage unit 15. The information center server 10 creates a book credit management table 200 corresponding to a settlement term, using the settlement data and the sales data 100 stored in the settlement data storage section 300. Thus, the book credit management table 200 include the sales data and the settlement data in an associated manner.

In accordance with the book credit management table 200, input mistakes in the sales data can be easily found by comparing, or calculating a difference 225 between, (sales subtotal−fee) 215 of the sales data 210 and a corresponding transfer amount of money 223 of the settlement/transfer detail data 220 in the book credit management table 200 (FIG. 7) for each date and for each card type.

At a request of the PC 40A, 40B or cell phone 70, the information center server 10 totals up/analyzes at least one of the settlement data and the sales data 100 stored in the settlement data storage section 300 of the storage unit 15, and then sends the processed results to the requesting PC device.

The ECRS 20A and 20B are connected to the electronic settlement terminals 30A and 30B, respectively, thereby allowing to relay the settlement data between the information center server 10 and each of the electronic settlement terminals 30A and 30B.

The embodiments and modifications described above illustrate the server, settlement system and programs according to the present invention as an example. Thus, the present invention is not limited to them.

While in the above embodiments the PC and cell phone are illustrated as the accessing terminals, the present invention is not limited to them. For example, another accessing terminal such as, for example, a PDA (Personal Digital Assistant) may be used.

When the accessing terminal is a portable device such as the cell phone 70, the user can request the information center server 10 to combine/total up/analyze the sales data and settlement data, and then receive and display the processed results on a display of the accessing terminal even when the user is away from his or her office. Data indicative of the processed results which the information center server 10 sends to the accessing terminal may be of an E-mail type.

While in the above embodiments and modifications the sales data and the settlement data are illustrated as used in an associated manner to create the book credit management table 200, they may be used in an associated manner to perform another process.

The information center server 10 may have the function of creating an account book such as, for example, an income statement needed for an account settling purpose based on the sales data and received cost/expenditure data. The information center server 10 also may be configured so as to remotely add/change messages concerning time services, logo marks, management messages, commodity names (or menu names), prices, etc., to be printed out on receipt sheets by the ECRs 20A and 20B.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2007-127992 filed on May 14, 2007 including specification, claims, drawings and summary. The disclosure of the above Japanese patent application is incorporated herein by reference in its entirety.

What is claimed is:

1. A server device comprising:
a first communication unit for communicating with a sales data processor and a settlement center;
a first storage unit; and
first control means for receiving sales data via the first communication unit from the sales data processor, for storing the sales data in the first storage unit, for receiving settlement data via the first communication unit from the sales data processor, for sending the received settlement data to the settlement center, for storing the settlement data in the first storage unit, and for processing the sales data and the settlement data stored in the first storage unit in an associated manner.

2. The server device of claim 1, wherein:
the sales data involves any particular settlement term and comprises a sale amount;
the settlement data involves the particular settlement term and comprises an amount of money for settlement; and
the first control means determines whether a totalization time has come, creates from the settlement data transfer data involving an amount of money to be transferred to an owner of the sales data processor when the totalization time has come, and creates management data which indicates whether the sales amount comprised by the sales data coincides with the amount of money to be transferred.

3. The server device according to claim 1, wherein the first control means performs at least one of totaling-up and analyzing processes on at least one of the sales data and the settlement data stored in the first storage unit, thereby producing a corresponding result.

4. The server device of claim 3, wherein:
the first communication unit is communicably connected to an accessing device;
the first control means receives a request for at least one of totaling-up and analyzing processes on the sales data from the accessing device via the first communication unit, performs at least one of the totaling-up and analyzing processes on the sales data in accordance with the request, and sends a result of the performing of the at least one of the totaling-up and analyzing processes via the first communication unit to the accessing device.

5. A settlement system comprising:
the server device and the sales data processor of claim 1; and wherein:
the sales data processor comprises:
a second communication unit for communicating with the server device; and
second control means for sending sales data involving sales amount data and settlement data involving an amount of money for settlement via the second communication unit to the server unit.

6. The settlement system of claim 5, further comprising:
an electronic settlement terminal connected communicably to the sales data processor for performing an electronic settlement operation; and wherein:
the second control means receives the settlement data from the electronic settlement terminal.

7. A software program product embodied in a computer readable medium which causes a computer to function as:
communicating means for communicating with a sales data processor and a settlement center;
storage means; and
control means for receiving sales data via the communicating means from the sales data processor, for storing the sales data in the first storage means, for receiving settlement data via the communicating means from the sales data processor, for sending the received settlement data to the settlement center, for storing the settlement data in the storage means, and for processing the sales data and the settlement data stored in the storage means in an associated manner.
